(19) United States
(12) Patent Application Publication
(10) Pub. No.: US 2010/0284760 A1
(43) Pub. Date: Nov. 11, 2010

(54) FASTENER FOR ATTACHING METAL PARTS

(75) Inventors: Michael S. Rotolo, North Royalton, OH (US); Kenneth E. Loy, II, Louisville, OH (US)

Correspondence Address: SAND & SEBOLT, AEGIS TOWER, SUITE 1100, 4940 MUNSON STREET, NW, CANTON, OH, 44718-3615, US

(73) Assignee: E-B DISPLAY COMPANY, INC., Massillon, OH (US)

(21) Appl. No.: 12/437,670

(22) Filed: May 8, 2009

(51) Int. Cl. F16B 13/00

(52) U.S. Cl. 411/44

(57) ABSTRACT

A fastener for use for attaching metal parts has a socket member and a stud member slidably and fixedly received therein. A flair portion on the socket member expands when abutted by a camming portion on the stud member to move the fastener between unlocked and locked positions. The head of the stud member includes a beveled edge which complementarily fits against a bevel abutment within the socket head. The bevel abutment extracts the stud member from the locked position by turning the stud member in either axial direction to ramp the stud member out of the socket member.

### BACKGROUND OF THE INVENTION

1. Technical Field

The present invention relates to a fastener which is used to fasten adjacent panels to each other. More particularly, the present invention relates to a turn fastener used to removably fasten together two panels, each having a rectangular aperture therethrough. Specifically, the removable turn fastener of the present invention is comprised of a stud element which fits into a receptacle element, wherein the receptacle element is sized to be removably received by the rectangular apertures of the panels. The removable turn fastener provides beveled edges and abutments to replace screw-type threading and prevent wear. The fastener further provides a low profile head in the locked position which is aesthetically pleasing and prevents snagging of material. Finally, the fastener may be locked and unlocked manually with only one hand using one quarter turn, and does not require the user to manually brace any part of the fastener while locking or unlocking.

2. Background Information

It is frequently desired, both in industrial and consumer products, to secure two or more panels, plates or sheet-like structures to one another. Many types of fasteners permit the panels to be separated and later refastened. However, although many types of fasteners have been commercially produced, and many more types have been proposed, there exists a need for improvements in the field.

One general type of fastener comprises a stud member which fits into a socket member positioned in a hole in a panel. The stud member may be rotated to expand the socket member outwardly and grip the edges or sidewall of the panel hole. One fastener of this general type is shown in U.S. Pat. No. 4,331,413 to Hoen, wherein a stud member fits into a socket member. Fingers on the end of the socket member are expanded through pressure from the stud member to grip the aperture sidewalls and prevent removal of the fastener. However, several distinctions and drawbacks exist in such fastener constructions which are remedied in the present invention.

Fasteners such as shown in Hoen are constructed and configured for securing panels through a round aperture. Round apertures and corresponding round socket members inherently may axially rotate with respect to one another due to the lack of rotation stopping edges. This is a significant problem when the means to secure the stud member to the socket member is through axial rotation of the stud member. This axial rotation of the stud member is transferred to the socket member and “slippage” occurs, typically resulting in the user holding the socket member with one hand, while rotating the stud member with the other. If the panels are sufficiently large such that the user cannot extend both arms around the panel, another user must be present to hold the socket member or rotate the stud member. Prior art fasteners such as shown in Hoen do not disclose how axial slippage of the socket member within the round aperture is prevented, and this may be a drawback to such fasteners.

A further drawback to such prior art fasteners is the extending nature of the stud member when the handle is rotated about its axis to open the fingers of the fastener. Upon rotation of the expanding handle, the stud member is moved upwardly along its axis. This extends the length of the entire fastener by the handle protruding outwardly when in the fastened position. For most typical fastener applications, a low profile of the stud member while in the fastened position is desired. There are many commercial and retail situations where it requires that a portion of the overlapping panels have no distinct protrusions generally above the plane of the panel itself. If the fastener is to be included in a retail setting, such as within a shelving unit, or display structure, the fastener head protruding out of the panels when in the locked position must be generally aesthetically pleasing as well as formed to not snag on any materials passing over it. These requirements are difficult to achieve with known fasteners wherein the stud member and ramp elements inherently extend from the fastener and panels.

A further drawback in the field of fasteners is the use of threading and screw-type structures to move the fastener between locked and unlocked positions. Threading tends to degrade with time, leading to “stripping” of the threads, rendering the fastener useless. Furthermore, when a user applies pressure to a stud member having threading, the user must be careful to not exert too much pressure on the stud member, or risk pushing the stud member over the threading. This requires the user to slowly rotate the stud member around through the threading, dramatically slowing down the assembly process of a large structure. Screw threading also typically requires more than a quarter turn to move the fastener from an unlocked to locked position. This is inefficient in both the time and effort of the user, as a fastener which uses screw-type threading to move the fastener from an unlocked to locked position will inherently require more time and concentration of the user.

Heretofore, existing turn fasteners have been characteristically inefficient and lacking in axial stability while the stud member is being rotated therein, requiring two hands or two users to complete the fastening process. Existing turn fasteners have been further inefficient in requiring a screw-type threading element and correspondingly inefficient fastening procedure. Furthermore, existing turn fasteners have been inefficient in reducing the profile of the stud member while in a fastened position.

Therefore, the need exists for a turn fastener having a socket member which is naturally stabilized while in the aperture and does not slip while the stud member is being rotated within. Furthermore, the need exists for a turn fastener which retracts the stud member entirely within the socket member when in the fastened position, and does not include threading elements or screw-type axial rotation to lock or unlock the fastener.

### BRIEF SUMMARY OF THE INVENTION

A primary object of this invention is to provide a fastener for securing plate-shaped metal parts and which can be manually and easily moved between a locked and unlocked position. The present invention provides for a non-threaded stud member rotating within a non-threaded socket member to expand and contract a squared shaped flair section to move the fastener between an unlocked and locked position.

Another object of the invention is provide a fastener which conforms to fit into a square hole.

A further object of the invention is to provide a fastener which may be used in a retail setting. The fastener has a low profile head when in the locked position to prevent materials from being snagged by a protruding member. The fastener head also is aesthetically pleasing to be viewed in a retail setting.

It is another object of the invention to provide a fastener which does not include threading such as found in a screw-type structure.

Another object of the invention is to provide a fastener which is locked and unlocked with one hand, and does not require the user to brace any portion of the fastener.

It is another object of the invention to provide a fastener which does not rotate axially within an aperture.

These features are obtained by the fastener for attaching metal parts, the general nature of which includes a fastener for securing together first and second plates, each plate having a rectangular hole formed therein, said fastener comprising: a socket member having a head, a lower flair portion and a shaft extending therebetween, said shaft having a plurality of walls forming a central bore having an imaginary axis and providing a rectangular configuration; and a stud member telescopically received in the bore of the socket member and having a lower camming portion engageable with the flair portion of the socket member for expanding the flair portion outwardly into clamping engagement with one of the plates and locking the stud member to the socket member upon axial and rotational movement of the stud member along and about the imaginary axis.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of the fastener of the present invention for attaching a pair of panels;

FIG. 2 is an exploded perspective view thereof;

FIG. 3 is a side elevational view of the stud member;

FIG. 4 is a front elevational view of the stud member;

FIG. 5 is a front elevational view of the socket member;

FIG. 6 is a front sectional view of the socket member;

FIG. 7 is a perspective view of the fastener for joining together two panels having square holes therein;

FIG. 8 is an enlarged sectional view taken on line 8-8 of FIG. 7 and with the fastener shown in section;

FIG. 9 is perspective view of the fastener in an unlocked position and placed into the square holes in the two panels of FIGS. 7 and 8;

FIG. 10 is an enlarged sectional view taken on line 10-10 of FIG. 9;

FIG. 11 is a sectional view taken on line 11-11 of FIG. 10;

FIG. 12 is a perspective view of the fastener in a locked position joining together the two panels; and

FIG. 13 is an enlarged sectional view taken on line 13-13 of FIG. 12.

Similar numbers refer to similar parts throughout the drawings.

### DETAILED DESCRIPTION OF THE INVENTION

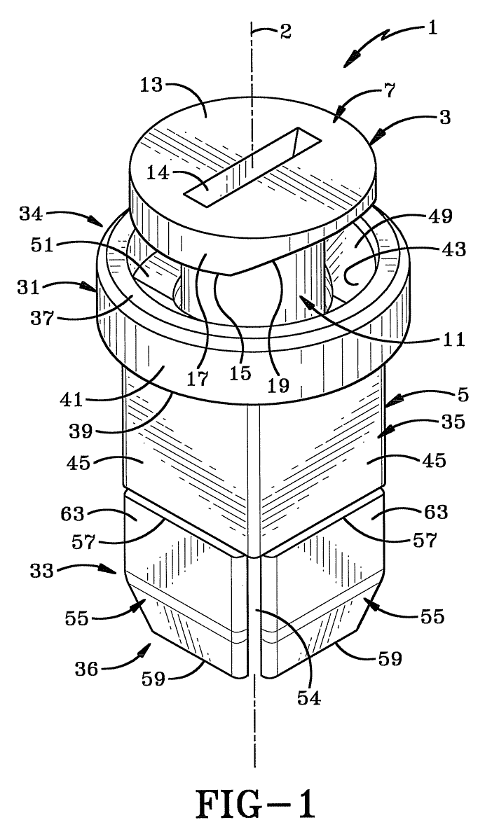

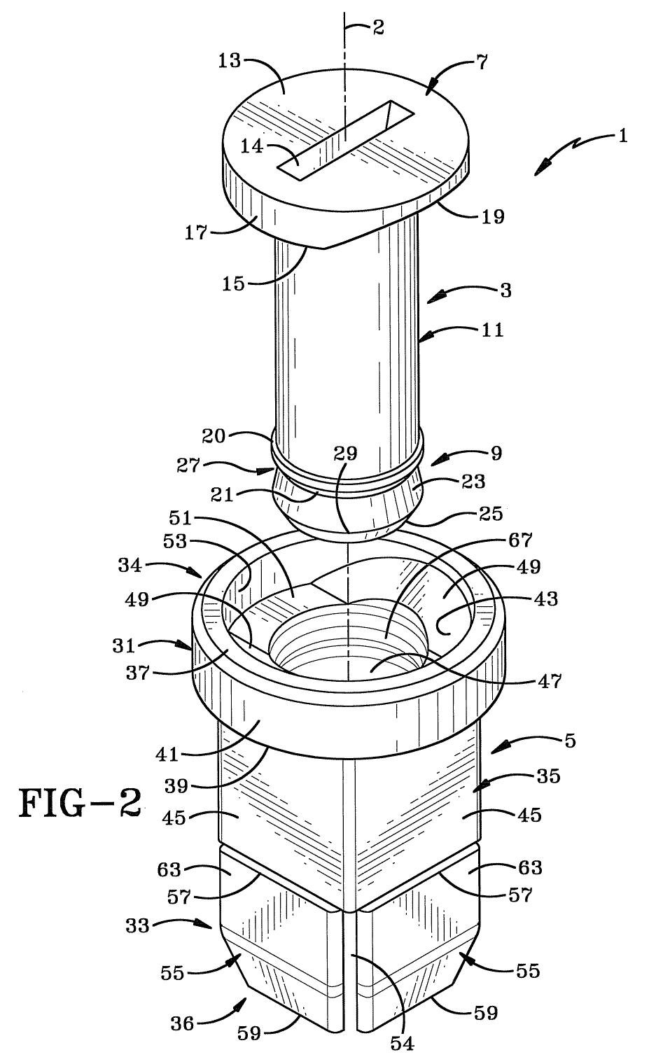

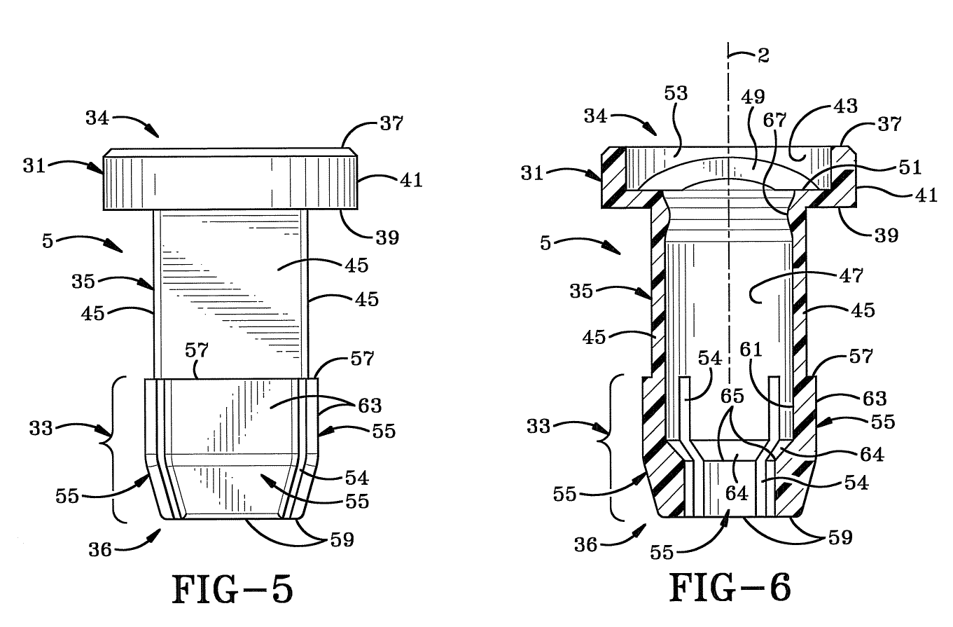

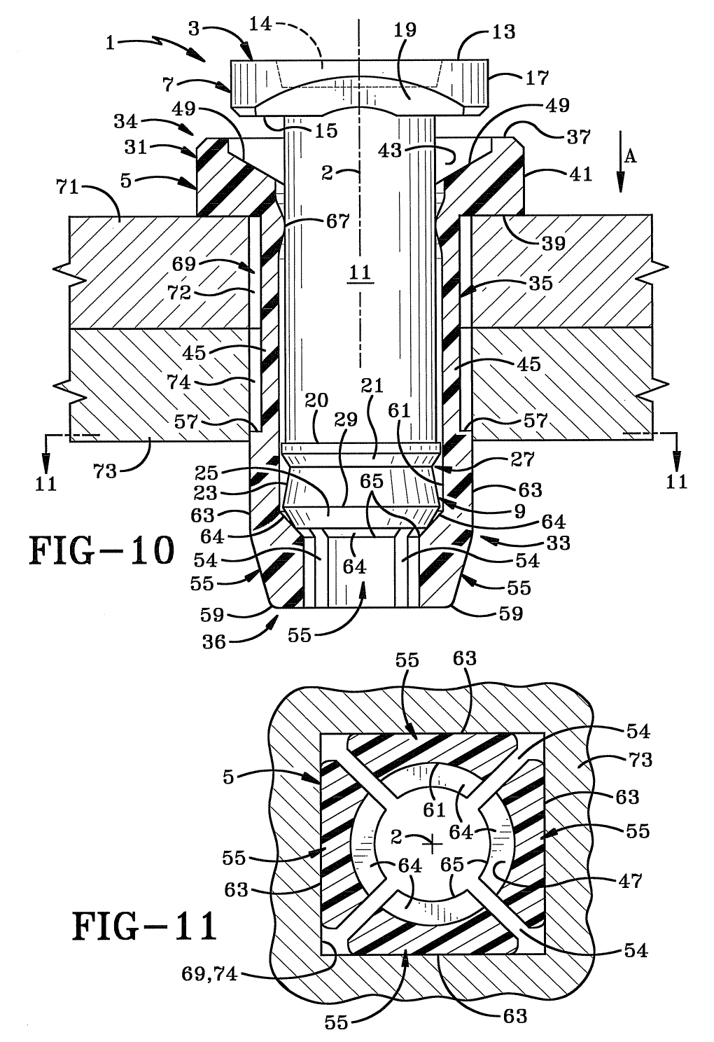

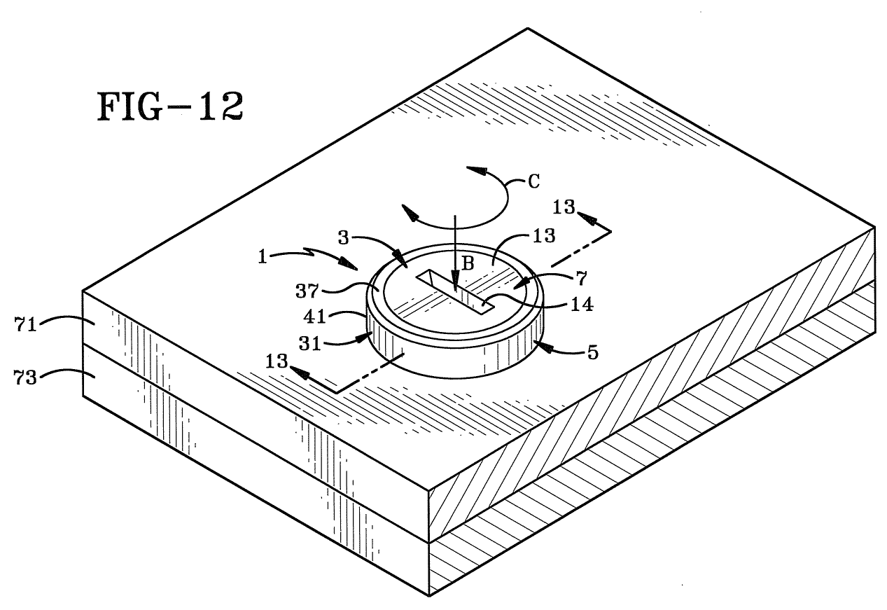

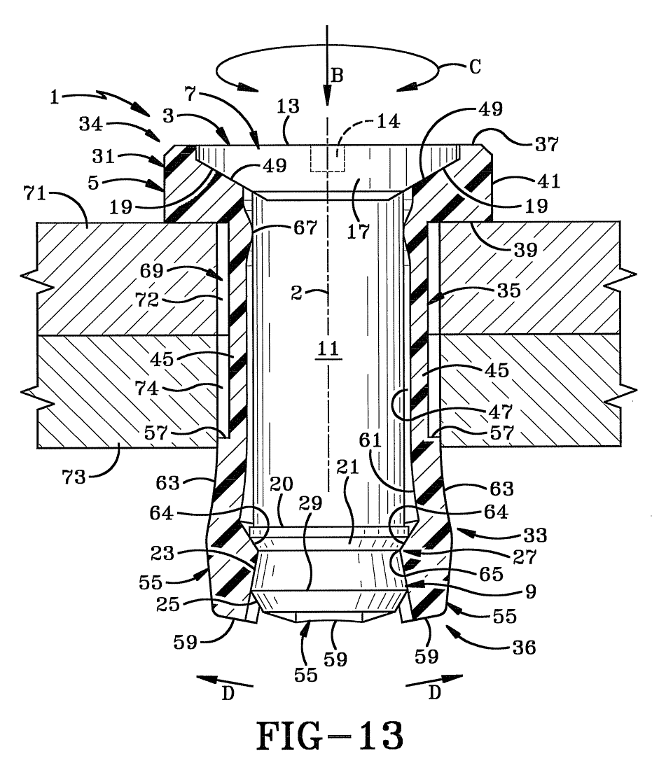

The fastener of the present invention is generally indicated at 1, and is shown in FIGS. 1-13. Referring to FIGS. 1 and 2, fastener 1 is comprised of a stud member 3 received by a socket member 5, and an imaginary central axis 2 extending the length of fastener 1. Fastener 1 operates to move between a locked position as shown in FIGS. 12 and 13 and an unlocked position as shown in FIGS. 1 and 10.

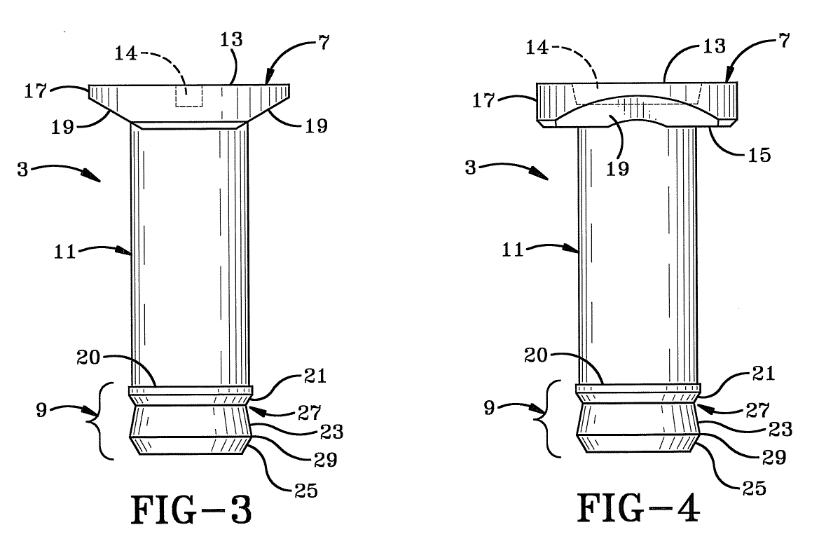

Referring to FIGS. 2-4, stud member 3 is comprised of a head 7, a lower camming portion 9, and a round cylindrical non-threaded shaft 11 extending therebetween. Head 7 has a flat top surface 13, a bottom surface 15 and a sidewall 17 extending therebetween and circumferentially axially about central axis 2 and having a diameter greater than that of shaft 11. Found in bottom surface 15 is a pair of spaced apart beveled edges 19. As shown in FIGS. 1 and 2, an elongated rectangular-shaped turn recess 14 is formed in the center of head 7. Camming portion 9 of stud member 3 is comprised of a first, second, and third sloped wall, 21, 23, and 25, respectively (FIGS. 3 and 4). First sloped wall 21 and second sloped wall 23 merge to form an annular recess 27. Second sloped wall 23 and third sloped wall 25 merge to form an annular cam ridge 29. An annular retainer shoulder 20 is formed on the lower end of shaft 11 and terminates at first sloped wall 21.

Referring to FIG. 2, 5, and 6, socket member 5 is comprised of an annular head 31, a lower flair portion 33, and a square shaft 35 extending therebetween. Head 31 includes a top rim 37, a bottom shoulder 39 and a cylindrical sidewall 41 extending axially therebetween about central axis 2. Rim 37 and sidewall 41 define an annular recess 43 formed in head 31 and is sized to receive head 7 of stud member 3 therein as shown in FIGS. 12 and 13. Square shaft 35 is comprised of four generally flat walls 45 arranged to form a generally square cross-sectional shape. Shaft walls 45 have a cylindrical hole or bore 47 extending the length of socket member 5 along central axis 2 and opening at top and bottom ends 34 and 36, respectively.

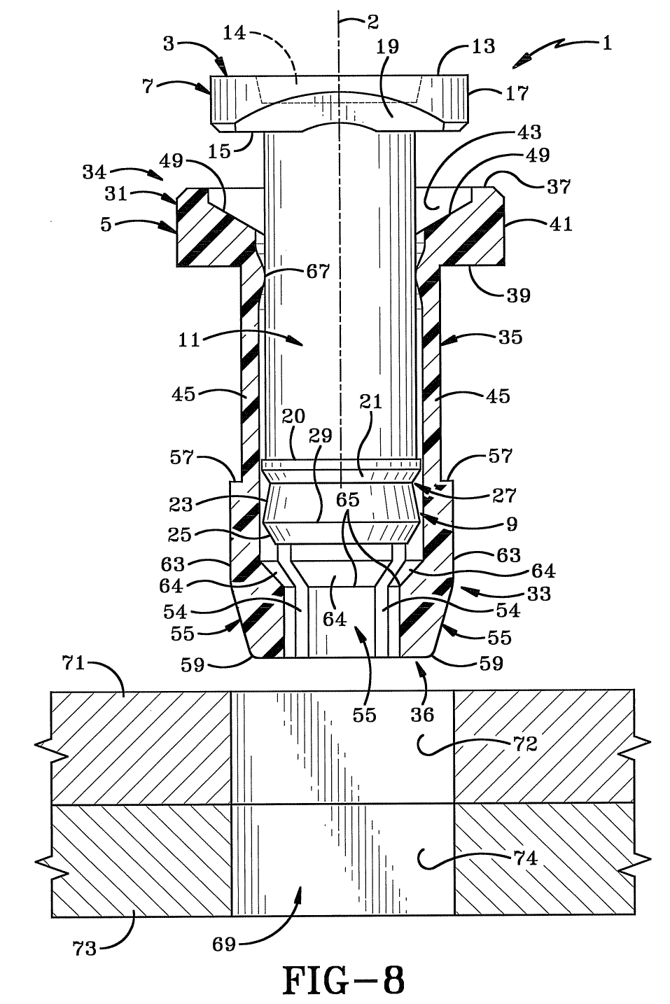

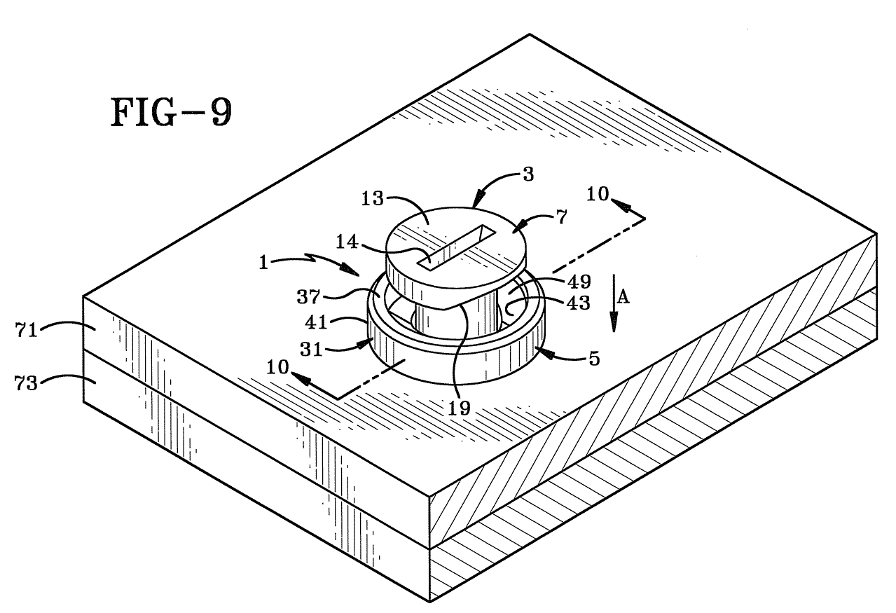

As shown in FIG. 6, a pair of spaced bevel abutments 49 extend from a recess base 51 along a cylindrical wall 53 which forms recess 43 and are sized to abut beveled edges 19 of stud member 3 when fastener 1 is in the locked position as shown in FIG. 13. Flair portion 33 extends from square shaft 35 and is comprised of four finger members 55 having a longitudinally extending space 54 between each pair of finger members. Each finger member 55 is an extension of shaft wall 45 and has a first or top end or shoulder 57 and a second or bottom end 59, an inner surface 61 and an outer surface 63. Each finger member 55 further includes a tapered shoulder 65 on inner surface 61 sized to complementary abut recess 27 of stud member 3 when fastener 1 is in the locked position. An annular inner stud retainer ring 67 is formed on stud walls 45 at the top end of bore 47 proximate bottom surface 39 of socket head 31 and extends inwardly towards axis 2 as shown in FIGS. 6 and 8.

The interaction between stud member 3 and socket member 5 of fastener 1 is shown particularly in FIGS. 1 and 7-13. Stud member 3 is slidably received and fixed within bore 47 of socket member 5. Stud member 3 is prevented from withdrawing and separating from top end 34 of socket member 5 by stud retainer ring 67. If stud member 3 is attempted to be withdrawn from socket member 5, stud retainer ring 67 abuts stud retainer shoulder 20 on shaft 11 and prevents shoulder 20 from passing ring 67. Conversely, stud member 3 is prevented from withdrawing and separating from bottom end 36 of socket member 5 by the base of recess 43. As stud member 3 is inserted axially in bore 47 towards bottom end 36, recess base 51 abuts bottom surface 15 of head 7 on stud member 3 and prevents stud member 3 from passing beyond the abutment point. Thus, stud member 3 is prevented from separating from socket member 5 at top end 34 and bottom end 36 once it is inserted into bore 47 of socket member 5.

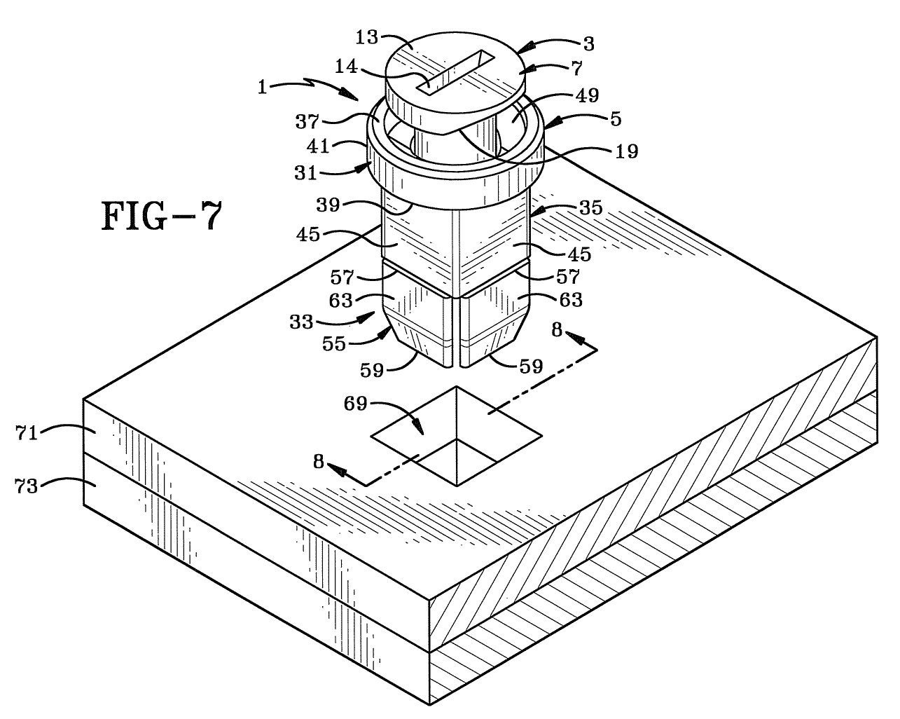

As shown in FIG. 7, fastener 1 is sized to be inserted into a complementary-shaped square hole 69 and fasten a first plate or panel 71 to a second plate or panel 73. Plates 71 and 73 each include a square aperture 72 and 74, respectively, which are aligned and sized to form square hole 69. As shown in FIG. 7-10, fastener 1 and more particularly first end 34 of socket member 5, including flair portion 33 and square shaft 35, enters hole 69 and penetrates until bottom surface 39 of socket member 5 abuts first plate 71 preventing socket member 5 from extending farther into hole 69. As shown in FIG. 10, manual pressure is applied to socket member 5 in the direction of Arrow A to push it into hole 69. When socket member 5 is fully inserted into hole 69, head 7 is abutting the top surface of plate 71. Camming portion 9 of stud member 3 does not actuate or cam finger members 55 outwardly while in the unlocked position as shown in FIG. 10. In this position, camming surface 25 will abut angled surfaces 64 of finger members 55 fully seating head 7 within recess 43 providing a flush fit therebetween.

As shown in FIGS. 12 and 13, to move fastener 1 from the unlocked position of FIG. 10 to the locked position of FIG. 13, manual pressure is exerted in the direction of Arrow B on stud member 3 moving stud member 3 farther into bore 47. Beveled edges 19 of stud head 7 must align with bevel abutment 49 within recess 43 of socket member 5 to fully lock fastener 1. A screwdriver or any other manual turning device is inserted into recess 14 to rotate stud member 3 one-quarter turn in the directions of Arrow C to properly align beveled edges 19 with bevel abutment 49, thus fully locking fastener 1. As shown in FIG. 13, fastener 1 is in the locked position having beveled edges 19 of stud member 3 properly and complementary aligned with bevel abutments 49 in recess 43 of socket member 5 and flat surface 15 of stud member 3 abutting recess base 51.

As stud member 3 is pressed in the direction of Arrow B (FIG. 13), a camming interaction occurs between camming portion 9 on stud member 3 and shoulder 65 on each finger member 55. As stud member 3 is pressed in the direction of Arrow B, third sloped wall 25 of camming portion 9 slides over a face 64 on shoulder 65. Each shoulder 65 on finger member 55 is cammed outwardly from central axis 2 in the direction of Arrows D until shoulder 65 passes over cam ridge 29. Next, the angle of second sloped wall 23 allows shoulder 65 to slightly retract towards central axis as stud member 3 moves against shoulder 65. Finally, shoulder 65 comes to rest positioned in recess 27 as a result of the complementary shape of face 64 and shoulder 65 with recess 27 formed by first sloped wall 21 and second sloped wall 23. Pressure from finger members 55 in the opposite direction of Arrows D holds shoulders 65 tightly within recess 27.

In the locked position of FIG. 13, finger members 55 are cammed outwardly from central axis 2 by stud member 3 giving flair portion 33 of socket member 5 a greater cross-sectional area than hole 69. Thus, flair portion 33 of socket member 5 cannot be retracted through square hole 69 while fastener 1 is in locked position 4. Correspondingly, head 31 of socket portion 5 cannot be retracted through hole 69 while fastener 1 is in either locked or unlocked positions. Thus, fastener 1 is not removable from square hole 69 when in the locked position and plates 71 and 73 are held securely together.

To move fastener 1 from the locked position to the unlocked position, stud member 3 is manually retracted in the opposite direction from Arrow C. As shown in FIGS. 12 and 13, top surface 13 of stud member 3 is horizontally flush with rim 37 of socket member 5, preventing a user from grasping the sides of head 7 to pull stud member 3 out of locked position 4. However, by manually turning stud member 3 one-quarter turn, beveled edges 19 slide away from bevel abutments 49 and the non-beveled sections of head 7 encounter bevel abutments 49. When non-beveled sections of head 7 are turned over bevel abutments 49, stud member 3 is drawn upwardly by the angled nature of bevel abutments 49 and released from the locked position. During this interaction, shoulder 65 slides out of recess 27 along second sloped wall 23, and finger members 55 retract to the original cross-sectional area, allowing fastener 1 to be withdrawn from hole 69.

In operation, a user places two plates 71 and 73 together, each having square apertures 72 and 74 respectively, which forms square hole 69. The user then places fastener 1 into hole 69, and more specifically places flair portion 33 and square shaft 35 into hole 69, with head 31 of socket member 5 preventing fastener 1 from entering farther into hole 69. Plates 71 and 73 may be of any type of material common in the art, but typically are comprised of metal sheeting. Furthermore, fastener 1 may have a shape and size generally complementary to hole 69 and will be packaged together for products such as shelving units or display racks, having a certain size or sizes of holes 69.

Once fastener 1 is placed into hole 69, the user moves fastener 1 from the unlocked position to the locked position by applying downward and rotational pressure on head 7 of stud member 3. This drives stud member 3 down into bore 47 of socket member 5, aligning beveled edges 19 and bevel abutments 49, and camming finger members 55 outwardly and away from central axis 2. Camming portion 9 forces shoulder 65 over cam ridge 29 and into recess 27. This holds finger members 55 extended outwardly from central axis 2 and prevents fastener 1 from being removed as flair portion 33 is larger than hole 69. The user is now free to manipulate plates 71 and 73 as a unit as they are securely fastened by fastener 1.

Conversely, when the user wants to remove fastener 1 from plates 71 and 73, the process is reversed. The user manually turns head 7 of stud member 3 one-quarter turn by use of a screw driver or similar device in recess 14, which rotates the non-beveled sections of head 7 over bevel abutment 49, drawing stud member 3 out of bore 47. Camming portion 9 retracts away from shoulder 65, thus allowing finger members 55 to retract and allowing flair portion 33 to pass through hole 69. Preferably hole 69 will be equal to or just slightly greater than the outer dimensions of flair portion 33. Fastener 1 is then removed and panels 71 and 73 can be separated from each other.

When turning head 7 of stud member 3, the user requires only one hand to move the fastener between locked and unlocked positions. Square shaft 35 abutting the walls of square hole 69 prevents axial movement of fastener 1 about central axis 2, allowing the user to turn stud member 3 without holding socket member 5. This dramatically increases the time to secure multiple fasteners 1 across a large plating structure as one user can place each fastener 1 in each square hole 69 and then quickly go down the line locking each fastener 1 with a pressured turn. Furthermore, head 7 of stud member 3 is recessed into head 31 of socket member 5 when fastener 1 is in the locked position as shown in FIGS. 12 and 13. The flush nature of head 7 and head 31 creates an aesthetically pleasing structure, which also prevents snagging of materials. This allows fasteners 1 to be used in a retail setting where customers may view fasteners 1 which provides an attractive appearance, as well as brush up against panels 71 or 73 without injuring the customer. Further, the beveled edges 19 acting in concert with bevel abutments 49, and the absence of threading allows fastener 1 to be used and reused much longer than a traditional screw-type of structure where the threads degrade over time and require a specific pressure when turning.

Although the above fastener members 3 and 5 are shown and described as being square-shaped and used in square-shaped holes, it is readily understood that other non-circular shapes could be used with satisfactory results by preventing rotation of the socket member 5 in hole 69 and preventing rotation of stud member 3 within bore 47 of socket member 5. Also, plates 71, 73 can be various other structures other than flat plates or panels which can be joined by fastener 1. Fastener 1 can be metal or plastic and function equally well in various fastening applications.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A fastener for securing together first and second plates, each plate having a multi-sided hole formed therein, said fastener comprising:
a socket member having a head, a lower flair portion and a shaft extending therebetween, said shaft having a plurality of walls forming a central bore having an imaginary axis and providing a multi-sided configuration; and
a stud member telescopically received in the bore of the socket member and having a lower camming portion engageable with the flair portion of the socket member for expanding the flair portion outwardly into clamping engagement with one of the plates and locking the stud member to the socket member upon axial and rotational movement of the stud member along and about the imaginary axis.

2. The fastener of claim 1 wherein the flair portion further comprises a plurality of flexible finger members extending from sidewalls of the shaft; and wherein each finger member has an inner face proximate the camming portion and a spaced apart outer face.

3. The fastener of claim 2 wherein the camming portion cams each finger member outwardly away from the central axis for moving the fingers into clamping engagement with one of the plates.

4. The fastener of claim 3 further comprising a shoulder extending from an inner face of each finger member toward the central axis; and wherein the camming portion abuts the shoulders to facilitate camming the finger members outwardly.

5. The fastener of claim 4 further comprising a recess formed in the camming portion sized to receive the shoulders of the finger members to secure the stud member in a locked position with the socket member.

6. The fastener of claim 5, further comprising a recess formed in the socket head; and in which the recess is sized to receive the head of the stud member when in the locked position.

7. The fastener of claim 6 further comprising at least one beveled edge formed on the head of the stud member and at least one bevel abutment formed in the recess of the socket head which is sized and shaped to abut the beveled edge on the head of the stud member when in the locked position.

8. The fastener of claim 7, wherein axial rotation of the stud member about the central axis when in the locked position axially rotates the beveled edge of the head away from the bevel abutment in the recess of the socket head so that the bevel abutment acts in a ramping manner to unlock the stud member from the socket member.

9. The fastener of claim 8, wherein the beveled edge of the head and the bevel abutment of the recess are spaced to unlock the stud member from the socket member with one quarter turn of the stud member about the central axis.

10. The fastener of claim 9, further comprising a recess formed in the head of the stud member and adapted to receive a manual turning mechanism to facilitate axial rotation of the stud member about the central axis.

11. The fastener of claim 1, further comprising a stud retainer ring extending inwardly into the bore of the socket member to retain the stud member within the bore of the socket member.

12. The fastener of claim 1, further comprising an outwardly facing surface on the head of the stud member and an outwardly facing surface on the head of the socket member, and wherein said outwardly facing surfaces are generally parallel and spaced apart when the fastener is in the unlocked position, and generally co-planer when the fastener is in the locked position.

13. In combination a pair of first and second plates, each plate having a rectangular hole formed therein, and a fastener for securing the plates together, said fastener comprising:
a socket member having a rectangular configuration inserted through the holes of the plates, said socket member having a head abutting the first plate and formed with an annular recess, a lower flair portion provided with a plurality of flexible fingers, a shaft extending between the head and flair portion, and a central bore extending through the head, shaft and flair portion;
a stud member telescopically received in the bore of the socket member, said stud member having a head, a lower camming portion and a shaft extending between the head and camming portion, said camming portion engaging internal surfaces of the flexible fingers to flex said fingers outwardly into clamping engagement against the second plate upon said stud member being moved axially and rotationally within the bore of the socket member from an unlocked position to a locked position with the socket member;
the head of the stud member being formed with at least one bevel edge which slidably engages a bevel abutment formed in the recess of the socket member head to move the stud member into the locked position with the socket member; and
the camming portion of the stud member having a recess engageable with shoulders formed on the interior surface of the flexible fingers to secure the stud member in the locked position and the flexible fingers in clamping engagement with the second plate.

14. The combination defined in claim 13, wherein the holes in the plates are square shaped; in which the lower flair portion of the socket member has four fingers providing a square configuration complementary to the plate holes; and in which the shaft of the stud member is cylindrical.

15. The combination defined in claim 14, wherein the axial rotation of the stud member slidably engages the bevel edge with the bevel abutment whereby the bevel abutment acts in a ramping manner to move the stud member into the unlocked position with the socket member.

16. The combination defined in claim 15, wherein the head of the stud member includes two bevel edges and whereby the bevel edges are spaced to move the stud member into the unlocked position with the socket member within one quarter axial turn of the stud member.

17. The combination defined in claim 13, further including a stud retainer ring extending inwardly into the bore of the socket member to retain the stud member within the bore of the socket, whereby the stud member may not be removed from telescopic engagement with the socket member.

18. A method of removably securing a pair of first and second plates with a fastener, each plate having a rectangular hole formed therein, the steps comprising:
inserting a socket member having a rectangular configuration into the rectangular holes of the plates until a head of the socket member abuts the first plate and a lower flair portion having a plurality of flexible fingers abuts the second plate;
engaging an internal surface of the flexible fingers with a lower camming portion of a stud member by manually telescopically plunging the stud member along a central bore extending the length of the socket member to flex the fingers outwardly into a clamping engagement against the second plate and move the fastener from an unlocked to a locked position;
holding the fastener in a locked position by engaging a recess formed in the lower camming portion of the stud member with a shoulder formed on the interior surface of the flexible fingers; and
releasing the fastener by manually axially rotating the stud member to telescopically retract the stud member within the central bore and thereby release the lower camming portion from engagement with the flexible fingers and move the fastener from the locked to the unlocked position.

19. The method described in claim 18, wherein the step of manually axially rotating the stud member to telescopically retract the stud member within the central bore further comprises:
slidably engaging an at least one bevel edge formed on a head of the stud member with an at least one bevel abutment formed in a recess of the socket member head;
ramping the bevel edge over the bevel abutment through the manual axial rotation of the stud member; and
telescopically retracting the stud member as the bevel edge rotates away from the bevel abutment.

20. The method described in claim 19, wherein the step of manually axially rotating the stud member further comprises:
engaging a manual turning mechanism with a recess formed in the head of the stud member; and
manually axially turning the turning mechanism to axially rotate the stud member and turn the stud member at most one quarter of the circumference of the socket member head.
